(19) United States
(12) Patent Application Publication
(10) Pub. No.: US 2024/0053057 A1
(43) Pub. Date: Feb. 15, 2024

(54) PTC Heating Device and Method for Manufacturing the Same

(71) Applicant: Eberspächer catem GmbH & Co. KG, Herxheim (DE)

(72) Inventors: Rüdiger Freitag, Landau (DE); Ulrich Mundt, Herxheim (DE); Michael Clade, Lambsheim (DE)

(21) Appl. No.: 18/232,655

(22) Filed: Aug. 10, 2023

(30) Foreign Application Priority Data
Aug. 12, 2022 (DE) 10 2022 120 453.7

(51) Int. Cl. F24H 3/04; H05B 3/06

(52) U.S. Cl. CPC F24H 3/0447; H05B 3/06; F24H 3/0452; H05B 2203/02; H05B 2203/017

(57) ABSTRACT

A PTC heating device has contact surfaces formed by a metallization, and also has first and second contact elements which are to be assigned different polarity and which are electrically contacted with the contact surfaces. Both of the first and second contact surfaces are circumferentially sealed by a frame that follows the contour of the respective contact surface and that is made of an electrically non-conductive adhesive coating. In the method of making the PTC heating device, the contact surfaces of the PTC element are contacted in an electrically conductive manner with the two contact elements, each of which has a strand an electrically non-conductive adhesive coating following the contour of the contact surfaces. During this contacting, the adhesive coating is displaced in such a manner that both contact surfaces are circumferentially sealed by a frame formed by the adhesive coating.

### BACKGROUND OF THE INVENTION

### 1. Field of the Invention

The present invention relates to a PTC heating device with at least one PTC element which comprises contact surfaces formed by metallization. At these contact surfaces, which are regularly configured on opposite main side surfaces of the PTC element regularly made of a ceramic, contact elements abut in an electrically contacting manner, which are to be assigned to different polarity. Thus, the PTC element is supplied with the power current via the contact elements.

### 2. Background of Related Art

The contact elements can be formed by contact sheets, which is likely to be the rule. However, the contact elements can also be formed by other electrically conductive structures, which can consist of one or more materials which do not necessarily have to be electrically conductive in each case. Thus, it is known to use expanded metal or also a wire mesh as contact element, the free spaces of which are filled by a good heat-conducting adhesive. With regard to a defined introduction of the power current, defined contact points, which are formed by the contact element and abut the contact surface in an electrically conductive manner, are sometimes also preferred.

A generic PTC heating device is known from EP 1 515 587 A1. In this prior art, the PTC heating device is received in a layered structure which includes corrugated fin layers in addition to the PTC heating device. A plurality of PTC heating devices and corrugated fin layers abutting them on both sides are received in a frame-shaped heater housing.

In the prior art mentioned above, a contact element in the form of a contact sheet, which forms a structural unit with a corrugated fin layer, is provided with an adhesive application. The adhesive application is disclosed in EP 1 515 587 A1 as a lacquer made of an electrically non-conductive material. This lacquer is applied over the surface of the contact element to fix the PTC element to the contact sheet. In this process, the PTC element is pressed against the contact sheet to thereby displace the lacquer between the PTC element and the contact sheet so that the PTC element is electrically conductively applied to the contact sheet. It should be understood that the PTC element has a certain roughness on its contact surface due to the manufacturing process. Even if a certain amount of the electrically non-conductive lacquer remains in the gap, roughness peaks penetrate the lacquer and make contact with the contact sheet.

The displaced lacquer accumulates on the outer circumference of the PTC element and causes a seal there, which surrounds the contact surface circumferentially. The opposite contact surface is contacted by applying the other contact sheet against the PTC element.

The proposal described from EP 1 515 587 A1 is permeated by the idea of a simplified manufacture. The lacquer is intended to fix the plurality of PTC elements one behind the other to the elongated contact sheet and thus enable handling of a structural unit.

### SUMMARY

The problem underlying the present invention is to provide a PTC heating device with increased electrical safety which can be manufactured economically. Further, the present invention intends to propose a corresponding manufacturing method.

It is proposed in the present invention to seal both contact surfaces circumferentially by a frame of an electrically non-conductive adhesive coating following the contour of the respective contact surface.

In contrast to the aforementioned prior art, the material forming the coating is limited to the frame. Neither outside the frame nor inside the frame, i.e. between the contact surfaces and the respective contact elements, there is usually material of the coating provided over the entire surface. This material is typically a silicone lacquer as basically known from EP 1 515 587 A1.

In the PTC heating device according to the invention, frames of the adhesive coating are located in each case on both sides of the contact elements between these and the contact surfaces of the PTC element. The frames are usually spaced apart from one another in the height direction of the PTC element, i.e. the frame assigned to one contact element does not contact the frame of the adhesive coating assigned to the other contact element.

The coating can be applied to the contact elements by screen printing, for example, or in the form of a line of adhesive compound metered in as a bead. The respective frames thereby have approximately the contour of the contact surface, which can correspond to the outer circumferential surface of the PTC element. The frame can also be slightly smaller than the contour of the PTC element, so that the frame extends only below the PTC element and surrounds it circumferentially, or both partially below the PTC element and outside the PTC element and surrounding it circumferentially. When coating a bead, through a suitable joining pressure it should be achieved that the adhesive coating is displaced as far as possible in the direction of the circumferential surface of the PTC element. In each case, a circumferential seal of the contact surface and thus the electrical conduction path between the PTC element and the contact element is the objective.

The PTC heating device according to the invention is used in particular in an electric heating device in a motor vehicle, which is operated with a power current of maximum 60 volts. Such electric heating devices can, for example, be installed in an electrically powered vehicle and operated at the appropriate voltage. The sealing of the contact surfaces creates sufficient electrical safety in this voltage range. The electric heating device may be in an HVAC in which air conditioning components are also provided. In particular with regard to this configuration, it is proposed by the present invention to configure the contact element as a non-coated contact sheet. The contact sheet can be formed from an aluminum base material, which can also be understood to mean pure aluminum. It has been shown that when using the contact sheet described in EP 1 515 587 A1, which there is a brass sheet provided with a tin coating, the tin coating detaches from the brass sheet under the action of a coolant and an applied voltage of 40-60 volts. The coolant can thereby leak into the HVAC from a leakage in the components provided for cooling the vehicle interior. The metallic particles thus dissolved lead to an electrically conductive path within the electric heating device, which results in a short circuit that ignites the hydrogen and ethylene glycol coolant generated in the conductive path. This damage path is prevented with the use of uncoated contact sheets which form the contact elements.

The metallization and the contact element can be manufactured from the same base material, typically configured to be identical in material. Thus, the metallization can be formed from an aluminum base material which corresponds to the aluminum base material of the contact element. By choosing the same material for forming the contact surface and the contact element, performance losses due to corrosion between the contact surface and the contact element are likely to be avoided.

However, electrically higher-grade metallization is also conceivable. Thus, the metallization can also be formed from a silver base material.

As known from the prior art EP 1 515 587 A1, also in the present invention the adhesive coating may serve to join the PTC element to the contact elements. A separate positioning frame, which is located between the two contact elements and has recesses into which PTC elements are inserted next to or behind one another and thus positioned at a predetermined position relative to the extension of the PTC heating device, can be dispensed with.

As generally known from the aforementioned prior art, at least one of the contact elements can be provided in a structural unit with a radiator layer. At least one of the contact elements, and typically both contact elements, form terminal lugs which usually penetrate the heater housing and form plug elements of a plug connection on the outside of the heater housing. Such a plug connection can also be effected to a control device, which is realized in a structural unit at the electric heating device.

To compensate for the lack of a positioning frame, according to a further embodiment of the present invention, it is proposed that at least one of the substantially planar contact surfaces of the PTC element be penetrated by a projection formed integrally by the PTC element or the contact sheet. This projection may be configured on the contact element. In this configuration, several projections may be provided distributed around the PTC element in such a way that its position on the contact surface defined by the contact element can only be changed to a limited extent. The corresponding projections can simplify appropriate positioning of an individual PTC element during assembly.

In the method for manufacturing a PTC heating device according to the invention, a PTC element is provided with a metallization that forms a contact surface. Contact sheets of different polarity are each provided with a strand of an electrically non-conductive adhesive coating following the contour of the contact surfaces. According to this, the contact surfaces are electrically conductively contacted with the two contact elements. In this process, the adhesive coating is displaced in such a way that, after the PTC heating device has been manufactured, both contact surfaces are circumferentially sealed by a frame formed by the adhesive coating. Subsequently, the frame of the PTC heating device according to the invention is the result of a displacement of the adhesive coating. The cross-sectional shape or final configuration of the frame is usually determined by the contour and surface of the PTC element.

### BRIEF DESCRIPTION OF THE DRAWINGS

Further details and advantages of the present invention will be apparent from the following description of an embodiment in conjunction with the drawing. Therein:

FIG. 1 shows an electric heating device;

FIG. 2 shows a side view of a length section of a part of the layering of the electric heating device according to FIG. 1, and

FIG. 3 shows a cross-sectional view along line III-III according to the illustration in FIG. 2.

### DETAILED DESCRIPTION

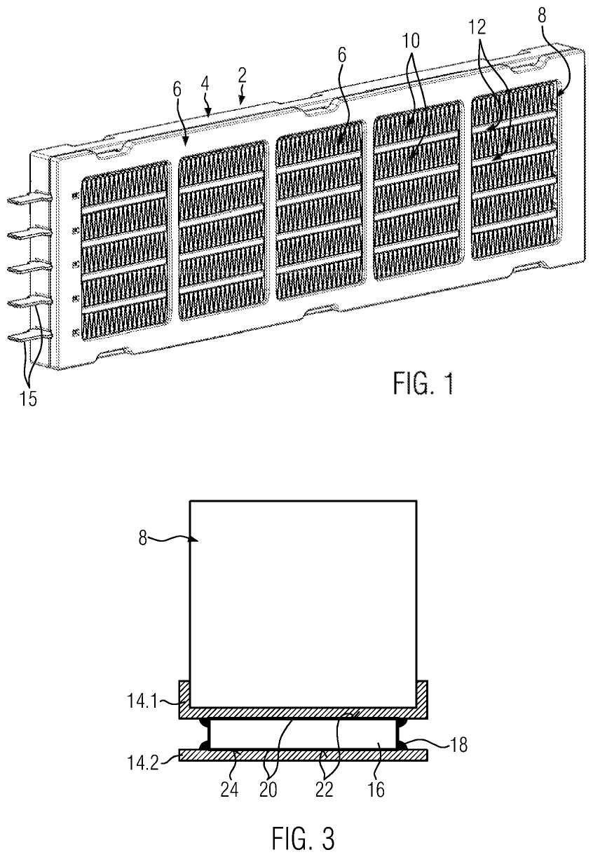

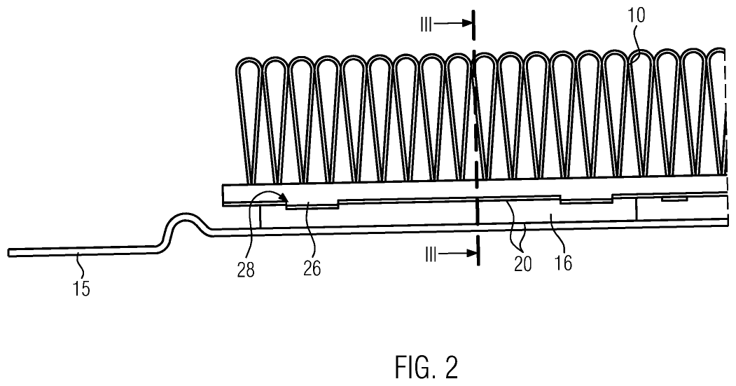

FIG. 1 shows a side view of an embodiment of an electric heating device 2 with a frame-shaped heater housing 4, in which a layered structure 6 is held under clamping of a spring not shown. The layered structure 6 comprises radiator layers 8, which have radiator elements 10 as an essential element, and PTC heating devices 12, details of which can be seen in FIG. 3.

The PTC heating devices 12 have opposing contact elements 14 in the form of contact sheets which protrude over a cross beam of the heater housing 4 to form connection tongues 15. The upper contact element characterized by reference sign 14.1 circumferentially embraces the radiator element 10. The upper contact element 14.1 is accordingly joined to the radiator element 10 to form a structural unit. A PTC element 16 is shown between the lower contact element 14.2 and the upper contact element 14.1.

Reference sign 18 characterizes two frames which are provided between the respective contact element 14.1, 14.2 and the PTC element 16 and surround this PTC element 16 circumferentially. The frames 18 are formed from a cured silicone adhesive. The silicone adhesive fastens the PTC element 16 to the respective contact element 14. Through the frame 18, a contact surface 24 formed by a metallization 20 on the main side surfaces 22 of the PTC element 16 is respectively sealed from the environment.

As can be seen in FIG. 2, projections 26 integrally formed thereon protrude from the contact element 14 and surround the PTC element 16 with little play on all circumferential sides of the PTC element 16 for form-fitting positioning in the scope of assembling the two elements 14, 16.

1. A PTC heating device comprising:
at least one PTC element which has first and second contact surfaces formed by a metallization and which has first and second contact elements to be assigned different polarities, wherein the contact elements are electrically contacted with the contact surfaces, wherein both of the first and second contact surfaces are circumferentially sealed by a frame which follows a contour of the respective contact surface and which is made of an electrically non-conductive adhesive coating.

2. The PTC heating device according to claim 1, wherein the metallization and the contact elements are made of the same base material.

3. The PTC heating device according to claim 1, wherein the contact elements are formed of an aluminum base material.

4. The PTC heating device according to claim 1, wherein the metallization is formed of a silver or aluminum base material.

5. The PTC heating device according to claim 3, wherein the metallization is formed of a silver or aluminum base material.

6. The PTC heating device according to claim 1, wherein the at least one PTC element and the contact elements are joined by the adhesive coating to form a structural unit.

7. The electric heating device according to claim 1, wherein the metallization and the contact elements are made of the same material.

8. An electric heating device for a motor vehicle, the electric heating device comprising:
a heater housing;
a layered structure that is received in the heater housing, the layered structure including at least one PTC heating device and radiator layers abutting against the PTC heating device on both of first and second sides thereof, wherein
the at least one PTC element which has first and second contact surfaces formed by a metallization and which has first and second contact elements to be assigned different polarities, wherein the contact elements are electrically contacted with the contact surfaces, wherein both of the first and second contact surfaces are circumferentially sealed by a frame which follows a contour of the respective contact surface and which is made of an electrically non-conductive adhesive coating.

9. A method for manufacturing a PTC heating device, comprising:
providing at least one PTC element having a metallization forming first and second contact surfaces,
providing first and second contact elements to be assigned different polarities, each of the contact elements being provided polarity with a strand of an electrically non-conductive adhesive coating following the contour of the contact surfaces, and
contacting the contact surfaces in an electrically conductive manner with the two contact elements, and,
during the contacting, displacing the adhesive coating in such a manner that both the first and second contact surfaces are circumferentially sealed by a frame formed by the adhesive coating.

10. The method according to claim 9, wherein the PTC element is coated with a metallic material corresponding to a base material of the contact elements for forming the contact surfaces.

11. The method according to claim 9, wherein the contact elements are made of an aluminum base material, and wherein the PTC element is coated with an aluminum base material.

12. The method according to claim 9, wherein the contact elements are made of an aluminum base material, and wherein the PTC element is coated with an aluminum base material.
